(19) United States
(12) Patent Application Publication
(10) Pub. No.: US 2010/0122916 A1
(43) Pub. Date: May 20, 2010

(54) Sensor with electrodes of a same material

(76) Inventors: Balakrishnan G. Nair, Sandy, UT (US); Brett Tamatea Henderson, Salt Lake City, UT (US); Thomas Koerner Pace, Salt Lake City, UT (US); Gangqiang Wang, Salt Lake City, UT (US)

Correspondence Address: CATERPILLAR/FINNEGAN, HENDERSON, L.L.P., 901 New York Avenue, NW, WASHINGTON, DC, 20001-4413, US

(21) Appl. No.: 12/292,458

(22) Filed: Nov. 19, 2008

(51) Int. Cl. G01N 27/26; B28B 1/00

(52) U.S. Cl. 205/794.5; 204/416; 205/775; 264/614

(57) ABSTRACT

A sensor for monitoring concentration of a constituent in a gas may include an ionically conductive layer and a sensing electrode coupled to the ionically conductive layer. The sensing electrode may be exposed to a gas. The sensor may also include a reference electrode that is exposed to the gas and made of substantially a same material as the sensing electrode.

### TECHNICAL FIELD

The present disclosure relates generally to a sensor, and more particularly, to a sensor with electrodes of a same material.

### BACKGROUND

The composition of exhaust produced by the combustion of hydrocarbon fuels is a complex mixture of oxide gases (NOₓ, SOₓ, CO₂, CO, H₂O), unburned hydrocarbons, and oxygen. Measurement of the concentration of these individual exhaust gas constituents in real time can assist in improved combustion efficiency and lower emissions of polluting gases. Prior art discloses a variety of sensors configured to measure a concentration of different exhaust gas constituents. In general, these sensors include Nernstian (also called equilibrium sensors) and non-Nernstian sensors (also called nonequilibrium sensors).

In Nernstian sensors, a reference electrode and a sensing electrode are exposed to different environments. These different environments may be environments containing gases that have different concentrations of a chemical species to be measured (different gases). When the two electrodes are exposed to different environments, an electric voltage is generated between the electrodes. This electric voltage is used as an indicator of the concentration of the chemical species. In these sensors, the measured electric voltage follows the Nernst equation. In Nemstian sensors, both the reference electrode and the sensing electrode may be made of a same or of different materials and the electric voltage between them is generated by the difference in electrochemical activity between the two electrodes due to the different environment that each electrode is exposed to.

In Non-Nernstian sensors, a reference electrode and a sensing electrode, made of different materials, are both exposed to same or different environments, and an electric voltage (indicative of the concentration of the electrochemical species) is measured between the two electrodes. In these sensors, the measured electric potential across the two electrodes do not follow the Nernst equation. In Non-Nemstian sensors, the electric voltage is generated due to the differences in electrochemical activity between the same gas and the different electrode materials.

Non-Nemstian sensors are used for the detection and measurement of various oxidizable (CO, NO, etc.) and reducible gases (O₂, NO₂, etc.). Typical non-Nemstian sensors include an ionically conductive electrolyte, such as yttria stabilized-zirconia (YSZ), a reference electrode, and a sensing electrode. The two electrodes are typically made of different materials which may include various metals, such as platinum (pt), and various perovskite-type metal oxides. Differences in the reduction/oxidation reactions occurring at the gas/electrode/electrolyte interface at the two electrodes may induce a potential difference between the two electrodes. These reduction/oxidation reactions (redox reactions) at the gas/electrode/electrolyte interface (triple phase boundary) are generally referred to herein as electrochemical activity. Some problems with non-Nernstian sensors known in the art include low sensitivity due to signal drift and the difficulty of maintaining a pristine reference voltage.

Hasei et al., U.S. Pat. No. 6,274,016, issued Aug. 14, 2001 (the '016 patent), discloses a NOₓ sensor having high sensitivity to NOₓ. The sensor of the '016 patent includes a reference and a sensing electrode formed on a zirconia solid electrolyte substrate. The sensitivity of the sensor of the '016 patent is increased by fabricating the reference electrode out of platinum and making the sensing electrode by laminating a layer of rhodium on a layer of platinum and dispersing zirconia in the laminated electrode. While the sensitivity of sensor of the '016 patent may be enhanced by the particular choice of the electrode materials, the sensor may have some of the other drawbacks discussed above. The disclosed sensor assembly is directed at overcoming shortcomings as discussed above and/or other shortcomings in existing technology.

### SUMMARY

In one aspect, a sensor for monitoring concentration of a constituent in a gas is disclosed. The sensor may include an ionically conductive layer and a sensing electrode coupled to the ionically conductive layer. The sensing electrode may be exposed to a gas. The sensor may also include a reference electrode that is exposed to the gas and made of substantially a same material as the sensing electrode.

In another aspect, a method of fabricating a sensor is disclosed. The method may include creating a sensing electrode on an ionically conducting substrate and creating a reference electrode on the ionically conducting substrate. The sensing electrode and the reference electrode may be made of a same material and have different microstructures. The method may also include positioning the sensing electrode and the reference electrode such that both the reference electrode and the sensing electrode are exposed to a same gas during operation of the sensor.

In yet another aspect, a method of measuring a constituent of a gas using a sensor is disclosed. The method may include directing the gas over a sensing electrode coupled to an ionically conducting substrate. The method may also include directing the gas over a reference electrode coupled to the ionically conducting substrate. The sensing electrode and the reference electrode may be made of a same material and have different microstructures. The method may further include measuring an electric voltage across the sensing electrode and the reference electrode. The electric voltage may be indicative of a concentration of the constituent.

### BRIEF DESCRIPTION OF THE DRAWINGS

FIG. 1 is a schematic of an exemplary sensor of the current disclosure;

FIG. 2 is an cross-sectional illustration of an exemplary sensor assembly of the current disclosure;

FIG. 3A is an illustration of an exemplary integrated sensor of the sensor assembly of FIG. 2;

FIG. 3B is a schematic illustration of a heating component and two sensing components included in the integrated sensor of FIG. 2;

FIG. 4 is a flow chart illustrating an exemplary method of fabrication of a sensing component of the sensor assembly of FIG. 2;

FIG. 5A is an scanning electron microscope (SEM) image of a sensing electrode of the sensor assembly of FIG. 2; and

FIG. 5B is a scanning electron microscope image of a reference electrode of the sensor assembly of FIG. 2.

### DETAILED DESCRIPTION

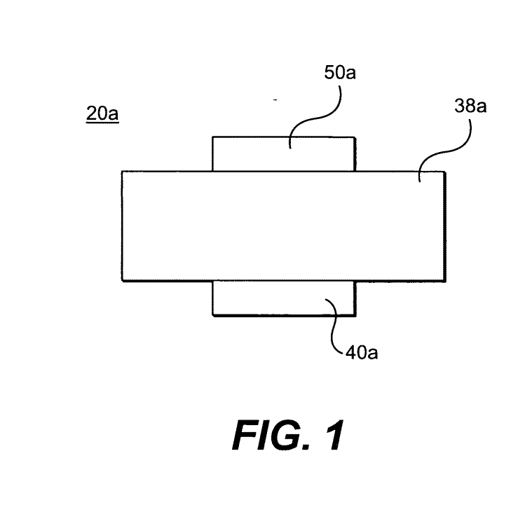

FIG. 1 illustrates an embodiment of a sensor 20A of the current disclosure. Sensor 20A may be a Non-Nernstian sensor. Sensor 20A may include a substrate 38A made of an ionically conductive material, and a reference electrode 40A and a sensing electrode 50A coupled to substrate 38A. Any ionically conductive materials known in the art, may be used as substrate 38A. Although reference electrode 40A and sensing electrode 50A are illustrated in FIG. 1 as being on opposite sides of substrate 38A, it is contemplated that, in some embodiments, both reference and sensing electrode 40A, 50A may be on same side of substrate 38A. Both reference electrode 40A and sensing electrode 50A may be made of substantially the same material. The term substantially the same material is used to account for the possibility that, although reference electrode 40A and sensing electrode 50A may be fabricated using the same material, in practice, impurities, contaminants, and trace elements of materials may cause some measurable differences in the materials of reference electrode 40A and sensing electrode 50B.

Reference electrode 40A and sensing electrode 50A, may however, have different microstructures. For example, the porosities and/or the pore size of the electrode material of the reference electrode 40A and sensing electrode 50B may be different. During operation, sensor 20A may be exposed to a gas having a chemical species as a constituent. The concentration of this chemical species may be measured by sensor 20A. The differences in electrochemical activity between the gas and the two electrodes, due to the differences in microstructure between the electrodes may generate an electric voltage between the two electrodes. This electric voltage may be indicative of the concentration of the chemical species in the gas. Although not shown in FIG. 1, sensor 20A may also include circuits that may be configured to measure the electric voltage between the reference and sensing electrodes 40A, 50A, and support structures that may be configured to enable sensor 20A to be applied to a specific application. In the description that follows, an embodiment of a sensor of the current disclosure that is used in an engine application will be described.

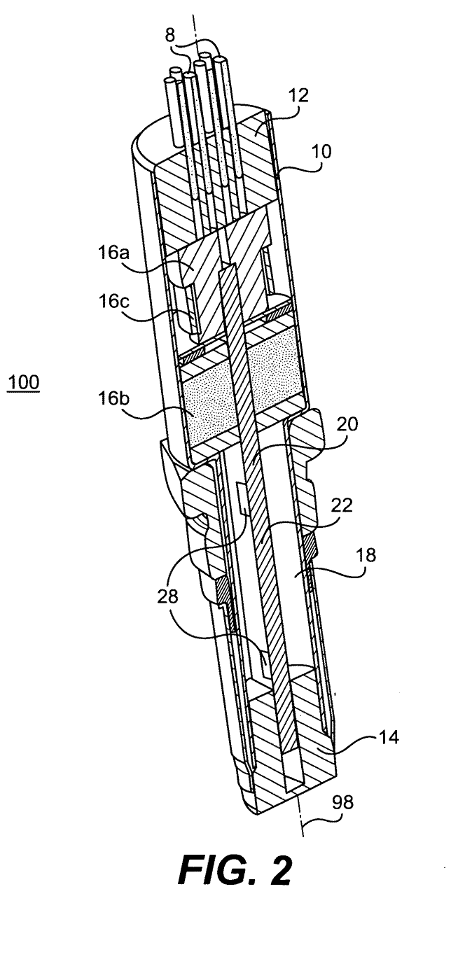

FIG. 2 is an illustration of a sensor assembly 100 that may be configured to measure constituents of exhaust gases of an engine. In such an application, sensor assembly 100 may be positioned in an exhaust duct that transports exhaust gases from the engine. Sensor assembly 100 may include multiple components enclosed in a housing 10, that cooperate to allow one or more constituents of the exhaust gas to be measured. These components may include an integrated sensor 20. Sensing component 20 may extend within housing 10 along a longitudinal axis 98. A grommet 12 and a flow head 14 may enclose integrated sensor 20 within housing 10. Housing 10 may also include components such as connectors and crimp rings (generally referred to herein as sealing members 16a, 16b, 16c) that constrain integrated sensor 20 snugly within housing 10. A measurement chamber 18 may also be enclosed within housing 10 along side integrated sensor 20. Flow head 14 may include inlet openings and passages (not shown) that direct exhaust gases flowing in the exhaust duct to the measurement chamber 18. These exhaust gases may pass though one or more catalysts (not shown) positioned in the flow path as they flow to the measurement chamber 18. The catalyzed exhaust gases may flow through the measurement chamber and exit housing 10 through an outlet opening (not shown) in flow head 14. Integrated sensor 20 may include one or more sensing regions 28 positioned in measurement chamber 18. Integrated sensor 20 may also include a heating component 22 configured to heat sensing regions 28 and the one or more catalyst positioned in flow head 14. The sensing regions 28 may measure the concentration of one or more exhaust gas constituents as they pass through measurement chamber 18. Terminals 8 that extend into housing 10 through grommet 12 may transfer this measured concentration to a control system of the engine.

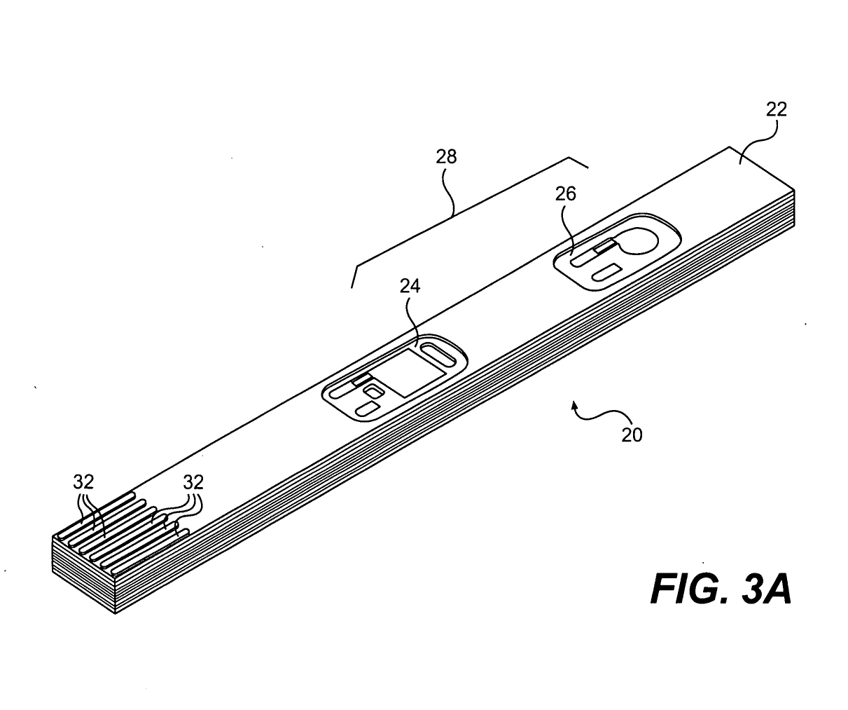

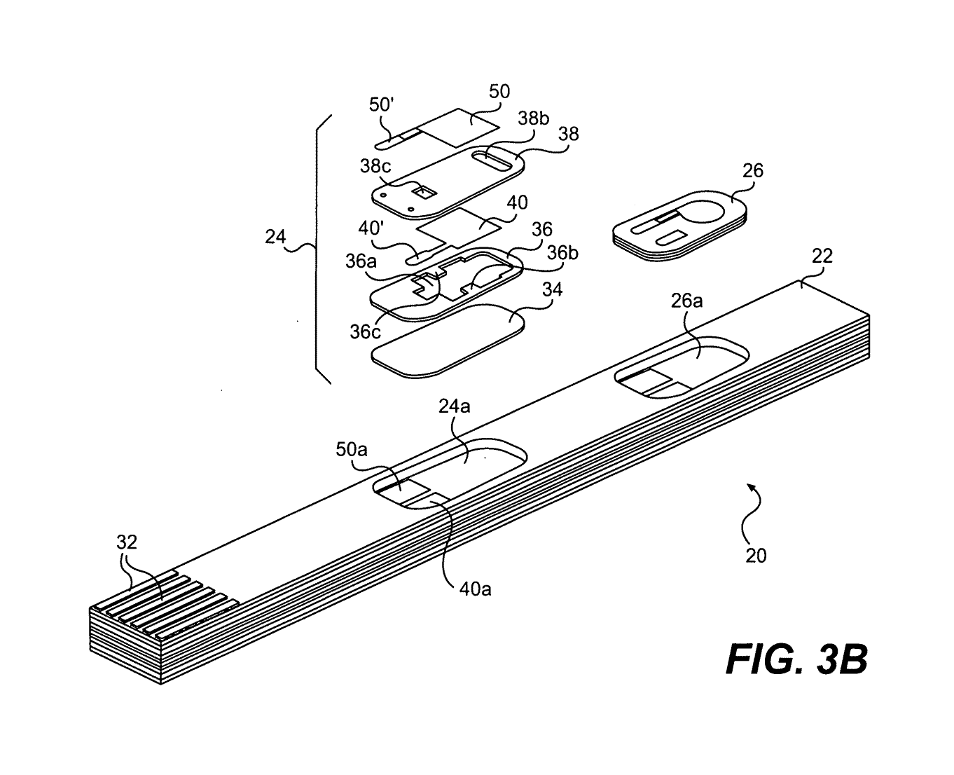

FIG. 3A illustrates integrated sensor 20 of sensor assembly 100. Integrated sensor 20 may be of a multilayer ceramic construction, and may include the one or more sensing regions 28. Although, in general, sensing regions 28 may include any number of sensing regions positioned anywhere on integrated sensor 20, in this discussion integrated sensor 20 is depicted as including two sensing regions positioned on one side thereof. These two sensing regions 28 may each be configured to measure a separate constituent of the exhaust gases. In some embodiments, one of these two sensing regions 28 may be an oxygen sensor 26 that is configured to measure a concentration of oxygen in the exhaust gases, and the second sensing region 28 may be a NO, sensor 24 that is configured to measure a concentration of NOₓ in the exhaust gases. As indicated before, sensor assembly 100 may include additional or different sensing regions than those described herein. Heating component 22 may include one or more heating elements (not shown) embedded in integrated sensor 20. In some embodiments, separate heating elements may be embedded below each sensing region to heat each sensing region independently. The heating component may also include electrical connections that electrically couple the heating elements, NOₓ sensor 24, and the oxygen sensor 26 to electrical contacts 32 of integrated sensor 20. Terminals 8 may electrically couple these contacts 32 to the control system of the engine.

FIG. 3B illustrates a schematic view of the sensing and heating components that make up sensor assembly 100. In addition to heating component 22 being of multi-layer ceramic construction, oxygen sensor 26 and NOₓ sensor 24 may also be of multi-layer ceramic construction. In the embodiment of FIG. 3B, oxygen sensor 26 may be an Nemstian sensor while NOₓ sensor 24 may be a non-Nemstian sensor. Heating component 22, NOₓ sensor 24 and oxygen sensor 26 may be fabricated separately and may be bonded together after fabrication. Heating component 22 may include cavities 24a and 26a that may be sized to fit NOₓ sensor 24 and oxygen sensor 26 therein. The separately fabricated NOₓ sensor 24 and oxygen sensor 26 may be positioned and bonded in the respective cavities 24a and 26a of heating component 22. Heating component 22 and oxygen sensor 26 may be of any type known in the art, and may be fabricated by any known fabrication technique. Since the construction and fabrication of heating component 22 and oxygen sensor 26 are well known in the art, they will not be discussed herein. The construction and method of fabrication of NOₓ sensor 24 is described in the following paragraphs.

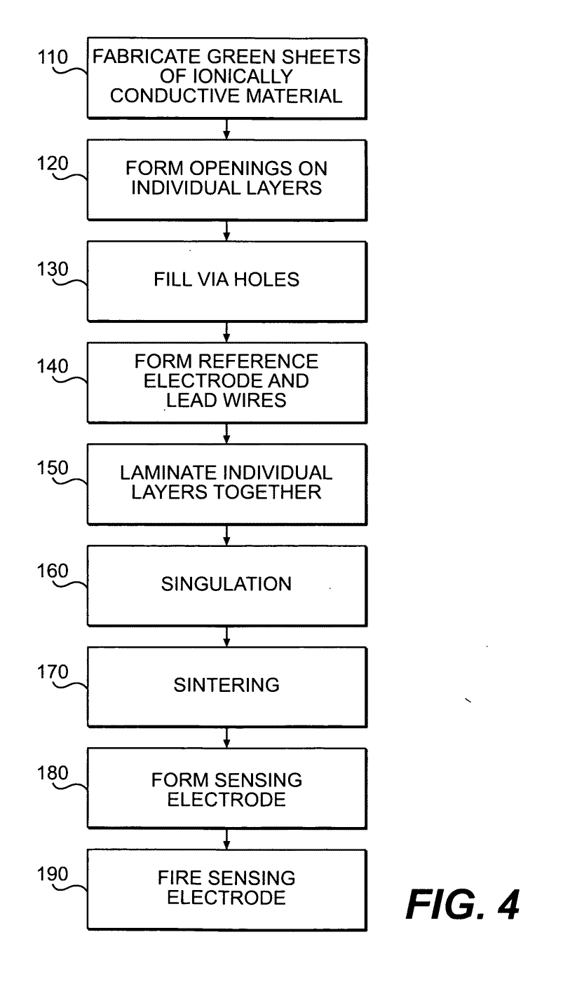

NOₓ sensor 24 may include multiple layers of ceramic sheets that are sandwiched together and sintered to form NOₓ sensor 24. FIG. 4 illustrates a flow chart for fabricating NOₓ sensor 24. In the description that follows, reference will be made to both FIGS. 3B and 4. The multiple layers of NOₓ sensor 24 may include a first layer 34, second layer 36, and a third layer 38. As is well known in the art, the design of NOₓ sensor 24 may include an open reference chamber. As will be described in more detail below, the individual layers of the NOₓ sensor 24 may include openings configured to form these reference chambers when they are laminated together.

First layer 34, second layer 36, and third layer 38 may be formed from a powder (or paste) of an ionically conductive material. As with substrate 38A of sensor 20A (illustrated in FIG. 1), any ionically conductive material known in the art may be used to fabricate first layer 34, second layer 36, and third layer 38 (step 110). In one exemplary embodiment, yttria stabilized zirconia (YSZ) may be used as the ionically conductive material. YSZ powder material may be mixed with binders, solvents, and/or plasticizers and tape cast and dried to form relatively flexible layers of YSZ. This relatively flexible form of the ceramic material is known in the art as green layers. Some of these green YSZ layers may include openings configured to form the reference chamber when the individual layers are laminated together.

The openings of the different layers may be formed on the green sheets by any technique known in the art, such as laser cutting (step 120). These openings may include opening 36a on second layer, and openings 38b and 38c on third layer. Holes, called via holes (not shown), may also be drilled through some or all of the layers in this step. When first layer 34, second layer 36, and third layer 38 are stacked together, opening 36a along with first layer 34 and third layer 38 may define the reference chamber, with openings 38b and 38c providing access to exhaust gases from measurement chamber 18 (see FIG. 2) into the reference chamber. The via holes may then be filled with an electrically conductive material (step 130) to conduct electrical signals between the different layers.

Reference electrode 40, and lead wires 40′, that electrically interconnect reference electrode 40 to a mating electrical connection 50b on heating component 22, may then be formed on one side of the green third layer 38 (step 140). Reference electrode 40 and the lead wires may be patterned on third layer 38 by any method, such as screen printing, known in the art. First layer 34, second layer 36, and third layer 38 may then be stacked together and laminated to assemble NOₓ sensor 24 (step 150). When the layers are stacked together, reference electrode 40 may be positioned in the reference chamber formed by openings 36a, 38b, and 38c. Lamination may be carried out under heat and pressure. The temperature and pressure used during lamination may depend upon the design of NOₓ sensor 24 and the specific material used as the ionically conductive material. In some embodiments, lamination may be carried out by stacking first layer 34, second layer 36, and third layer 38, and subjecting the stack to a pressure between about 1,500-10,000 psi and a temperature between about 25-100° C.

The shape of openings 36a, 38b, and 38c may be such that an unsupported span of third layer 38 above the reference chamber is minimized. Minimizing the unsupported span of the third layer 38 may improve the structural integrity of the reference chamber, and help preserve the shape of the reference chamber during lamination and other subsequent operations. In one embodiment, projections 36b and 36c (see FIG. 3B) may be provided on second layer 36 to support third layer 38 above the reference chamber. Although rectangular projections 36b, 36c that project into opening 36a from opposite side walls of second layer 36 are depicted in FIG. 3B, it should be emphasized that these projections may have other shapes, sizes, and orientations.

In some embodiments, multiple NOₓ sensors 24 may be included in the same stack of layers. In these embodiments, individual NOₓ sensors 24 may be singulated from the stack after lamination (step 160). Any processes known in the art, such as laser cutting, sawing, punching, etc., may be used for singulation. The singulated NOₓ sensors 24 may then be sintered to drive the organic components off the green ceramic and densify the ceramic material (step 170). Sintering may be carried out by exposing the laminated NOₓ sensors 24 to a high temperature for a prolonged time. Sintering may form a NOₓ sensor 24 of unitary structure with reference electrode 40 and the electrical connections to the reference electrode 40, embedded therein. The time-temperature profile employed during sintering may depend upon the application. As an illustrative example, if a YSZ based ionically conductive material is used to fabricate NOₓ sensor 24, sintering may include heating the stacked and laminated layers (first layer 34, second layer 36, and third layer 38) together for a temperature greater than about 1000° C. for over 2 hours. In some embodiments, the sintering may include heating the laminated layers to a temperature greater than about 1300° C. for about 2 hours or more.

Sensing electrode 50, along with lead wires 50′ that electrically couple the sensing electrode 50 to the mating electrical connection 50b on heating component 22, may then be formed on the sintered NOₓ sensor 24 (step 180). Any known method, such as screen printing, may be used to form the sensing electrode 50. The NOₓ sensor 24 may then be heated (“fired”) to adhere the sensing electrode material to the ceramic material of NOₓ sensor 24. As is known in the art, the firing conditions may depend upon the application. In some embodiments, firing may include heating the NOₓ sensor 24 to a temperature between about 800-1400° C. for about 15 minutes to about 2 hours.

In NOₓ sensor 24, both reference electrode 40 and sensing electrode 50 may be made of substantially the same material but may have different microstructures. For example, the porosities and/or the pore size of the electrode material of the reference electrode 40 and sensing electrode 50 may be different. These different microstructures may be created by any known technique. For instance, the sintering conditions and firing conditions may be controlled to obtain a desired microstructure of reference electrode 40 and sensing electrode 50, respectively. In some embodiments, the maximum temperature that one of the electrodes (reference electrode 40 or sensing electrode 50) is exposed to during the manufacturing process may be at least 50° C. lower than the maximum temperature that the other electrode is exposed to during the manufacturing process. This difference in temperature may assist in forming reference electrode 40 and sensing electrode 50 having different microstructures.

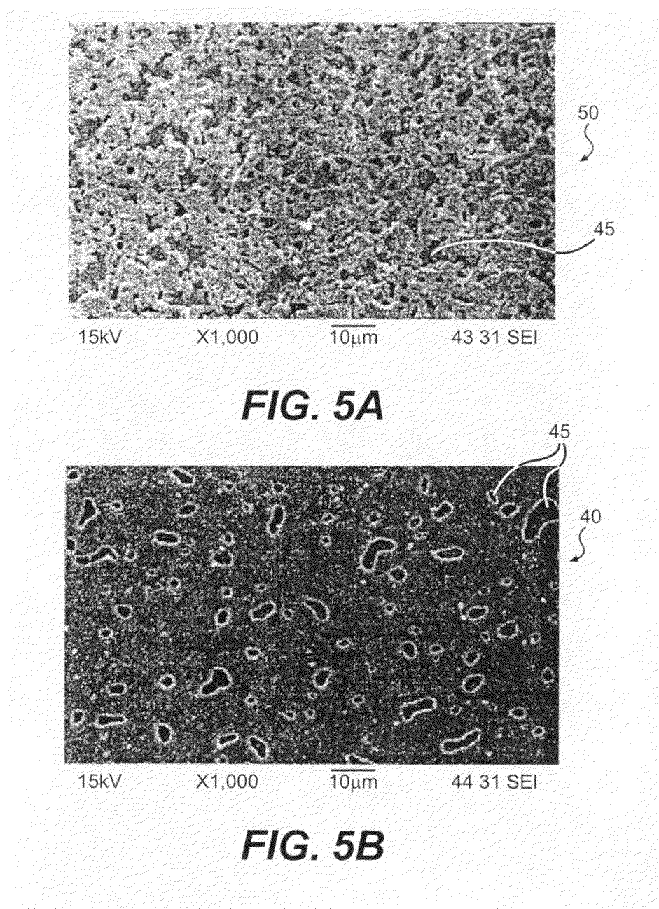

J FIGS. 5A and 5B show scanning electron microscope (SEM) images of sensing electrode 50 and reference electrode 40, respectively, having different microstructures (including porosity and pore size). In this disclosure, porosity is generally defined as the percentage area occupied by pores 45 in a unit area of the material. The difference in microstructure may produce a difference in the length of the triple phase boundary (gas-electrode-electrolyte interface) at the reference electrode 40 and the sensing electrode 50. The difference in length of the triple phase boundary may cause a difference in electrochemical activity at the two electrodes (reference electrode 40 and sensing electrode 50). This difference in electrochemical activity at the two electrodes may generate an electric voltage, which is indicative of the concentration of a chemical species in the gas, across these two electrodes.

In general, any metal or metal oxide (such as platinum (Pt) and perovskite-type oxides) may be used as the electrode material. The reference electrode 40 and sensing electrode 50 may also have any microstructure as long as the microstructure of the two electrodes are different. In some embodiments, reference electrode 40 and sensing electrode 50 may have different porosities and/or pore sizes. In some embodiments, the porosity and/or pore size of the reference electrode 40 may be greater than the porosity and/or pore size of the sensing electrode 50, while in other embodiments, the porosity and/or pore size of the sensing electrode 50 may be greater than the porosity and/or pore size of the reference electrode 40. In some embodiments, the ratio of the porosities of the two electrodes may be greater than or equal to about 1.3.

### Industrial Applicability

The presently disclosed sensor may be utilized to measure the concentration of a chemical species in a gas. In one embodiment, the sensor may be used to measure the concentration of one or more chemical species in an exhaust flow of an engine, while maintaining a high degree of accuracy. Heating and sensing components, that make up the sensor, may be separately fabricated and bonded together to form the sensor. The sensing components may include both Nemstian sensor and non-Nernstian sensors. The non-Nernstian sensors may include a reference electrode and a sensing electrode made substantially from the same material, but having different microstructures. The difference in microstructure of the two electrodes may cause a difference in electrochemical activity at the two electrodes, thereby generating a voltage across the two electrodes.

Fabricating the two electrodes of the same material having different microstructures may improve accuracy and reliability of the sensor by reducing signal drift and high oxygen sensitivity. In operation, both sensing and reference electrodes are exposed to the same oxygen partial pressure. The electric potential caused by different oxygen partial pressures at the two electrodes may thereby be minimized. In other words, the change in the oxygen concentration at the two electrodes may have little or no influence on the output signal. By controlling the microstructure of the reference electrode and the sensing electrode, the rate of electrochemical reaction at the two electrodes may be controlled, thereby reducing signal drift.

It will be apparent to those skilled in the art that various modifications and variations can be made to the disclosed sensor. Other embodiments will be apparent to those skilled in the art from consideration of the specification and practice of the disclosed sensor. It is intended that the specification and examples be considered as exemplary only, with a true scope being indicated by the following claims and their equivalents.

We claim:

1. A sensor for monitoring concentration of a constituent in a gas, comprising:
an ionically conductive layer;
a sensing electrode coupled to the ionically conductive layer, the sensing electrode being exposed to the gas; and
a reference electrode exposed to the gas and made of substantially a same material as the sensing electrode.

2. The sensor of claim 1, wherein a microstructure of the sensing electrode and the reference electrode are different.

3. The sensor of claim 1, wherein the sensing electrode and the reference electrode are made of platinum.

4. The sensor of claim 3, wherein the ionically conductive layer is made of a YSZ based material.

5. The sensor of claim 1, wherein the reference electrode is coupled to the ionically conductive layer.

6. The sensor of claim 1, wherein the reference electrode is positioned in an open reference chamber within the ionically conductive layer, and the ionically conductive layer includes openings configured to direct the gas into the open reference chamber.

7. The sensor of claim 6, wherein the ionically conductive layer includes one or more projections configured to reduce an overhang of the open reference chamber.

8. The sensor of claim 1, wherein the sensor is a non-Nemstian sensor.

9. The sensor of claim 1, wherein one of a porosity and a pore size of the sensing electrode and the reference electrode are different.

10. The sensor of claim 1, wherein the reference electrode and the sensing electrode are both exposed to the gas having substantially a same concentration of constituents.

11. A method of fabricating a sensor, comprising:
creating a sensing electrode on an ionically conducting substrate;
creating a reference electrode on the ionically conducting substrate, the sensing electrode and the reference electrode being made of a same material and having different microstructures; and
positioning the sensing electrode and the reference electrode such that both the reference electrode and the sensing electrode are exposed to a same gas during operation of the sensor.

12. The method of claim 11, wherein creating the reference electrode includes exposing the reference electrode to a maximum temperature that is at least 50° C. different than a maximum temperature that the sensing electrode is exposed to while creating the sensing electrode.

13. The method of claim 11, wherein creating the reference electrode includes sintering the ionically conducting substrate, the sintering creating a first microstructure on the reference electrode.

14. The method of claim 13, wherein creating the sensing electrode includes firing the ionically conducting substrate, the firing creating a second microstructure on the sensing electrode, the first microstructure being different from the second microstructure.

15. The method of claim 11, wherein creating the reference electrode includes creating the reference electrode having a first porosity, and creating the sensing electrode includes creating the sensing electrode having a second porosity different from the first porosity.

16. The method of claim 11, wherein creating the reference electrode includes creating the reference electrode having a first pore size, and creating the sensing electrode includes creating the sensing electrode having a second pore size different from the first pore size.

17. A method of measuring a constituent of a gas using a sensor, comprising:
directing the gas over a sensing electrode coupled to an ionically conducting substrate;
directing the gas over a reference electrode coupled to the ionically conducting substrate, the sensing electrode and the reference electrode being made of a same material and having different microstructures; and
measuring an electric voltage across the sensing electrode and the reference electrode, the electric voltage being indicative of a concentration of the constituent.

18. The method of claim 17, wherein the measured electric voltage does not follow the Nernst equation.

19. The method of claim 17, wherein directing the gas over the reference electrode and directing the gas over the sensing electrode both include directing the gas having substantially a same concentration of the constituent over both electrodes.

20. The method of claim 17, wherein the ionically conducting substrate is made of a YSZ based material and both the sensing electrode and the reference electrode are made of platinum.
